(19) United States
(12) Patent Application Publication
(10) Pub. No.: US 2026/0356711 A1
(43) Pub. Date: Nov. 12, 2026

(54) DEVICE TO PRODUCE CUSTOM TDS LEVELS IN DRINKING WATER

(71) Applicant: Midea Group Co., Ltd., Foshan (CN)

(72) Inventor: Ryan Prince, Louisville, KY (US)

(73) Assignee: Midea Group Co., Ltd., Foshan (CN)

(21) Appl. No.: 19/204,090

(22) Filed: May 9, 2025

(51) Int. Cl. C02F 1/68; C02F 1/00; C02F 103/02

(52) U.S. Cl. CPC C02F 1/688; C02F 1/008; C02F 2103/02; C02F 2201/005; C02F 2201/006; C02F 2209/105; C02F 2209/40; C02F 2301/046

(57) ABSTRACT

A remineralization device to create a custom mineral content or total dissolved solids (TDS) level in water using recirculation-based mineralizing. The remineralization device includes a remineralizing cartridge for dissolving minerals, multiple valves for controlling water flow, and a pump for circulating water until the custom TDS level is reached. The valves control the amount of water flowing through the remineralizing cartridge, forming a loop between the remineralizing cartridge and a parallel path. The water is recirculated through the remineralizing cartridge until the custom TDS level is reached.

### PRIORITY

This disclosure relates, in general, to a water processing system and, not by way of limitation, to adjusting water minerals level, among other things.

Water purification and mineralization are fundamental for ensuring safe and healthy water for various uses. Purification removes harmful contaminants such as bacteria, viruses, heavy metals, and chemicals, significantly reducing the risk of waterborne diseases and protecting public health. Water purification is also helpful in preserving the environment by preventing pollution of natural water bodies, which is essential for maintaining healthy ecosystems. Additionally, purified water is necessary for industrial and agricultural applications, ensuring the efficiency and safety of these operations.

Mineralization enriches purified water with essential minerals like calcium and magnesium, which are beneficial for human health and improve the taste and quality of the water. This process helps maintain the natural balance of minerals that can be disrupted during purification. However, water purification has its limitations, including high costs, energy consumption, and the generation of waste byproducts. Traditional methods may not effectively remove all contaminants, such as emerging pollutants like pharmaceuticals and microplastics, and entail regular maintenance to remain effective.

### SUMMARY

In one embodiment, the present disclosure provides a remineralization device to create a custom mineral content or total dissolved solids (TDS) level in water using recirculation-based mineralizing. The remineralization device includes a remineralizing cartridge for dissolving minerals, multiple valves for controlling water flow, and a water pump for circulating water until the custom TDS level is reached. The valves control the amount of water flowing through the remineralizing cartridge, forming a loop between the remineralizing cartridge and a parallel path. The water is recirculated through the remineralizing cartridge until the custom TDS level is reached.

In an embodiment, a remineralization device to create a custom mineral content or TDS level in water using recirculation-based mineralizing. The remineralization device includes a remineralizing cartridge for dissolving minerals, multiple valves for controlling water flow, and a water pump for circulating water until the custom TDS level is reached. The valves control the amount of water flowing through the cartridge, forming a loop between the remineralizing cartridge and a parallel path. The water is recirculated through the remineralizing cartridge until the custom TDS level is reached. The remineralization device further includes a TDS sensor to monitor TDS levels and a water tank to collect and increase the amount of water that can be remineralized at one time. The valves are fluidly connected to a point upstream and a second point downstream of the remineralizing cartridge via the parallel path to optionally bypass the remineralizing cartridge and provide low TDS water. Additionally, the remineralization device has a user interface that allows a user to choose from various modes between set TDS levels, and/or input the custom TDS level based on user preferences. The remineralization device further creates a custom mineral content or TDS level in water by soaking in water the mineral particles of the remineralizing cartridge and collecting water in a water tank when the custom TDS level is reached. The remineralization device uses soak-based mineralizing operable to configure a valve in line with the remineralizing cartridge to control water flow the remineralization device and close the valve after a set amount of water enters the remineralizing cartridge. It further opens the valve when the custom TDS level is reached and collects water in a water tank that is fluidly connected to the outlet of the remineralizing cartridge.

In another embodiment, a method for creating a custom mineral content or total dissolved solids (TDS) level in water at a remineralization device using recirculation-based mineralizing. The remineralization device includes a remineralizing cartridge for dissolving minerals, multiple valves for controlling water flow, and a water pump for circulating water until the custom TDS level is reached. In one step, the method includes using valves to control the amount of water flowing through the cartridge, forming a loop between the cartridge and a parallel path. The water is recirculated through the remineralizing cartridge until the custom TDS level is reached. The remineralization device further includes monitoring TDS levels via a TDS sensor and collecting water in a water tank and increasing the amount of water that can be remineralized at one time. The valves are fluidly connected to a point upstream and a second point downstream of the remineralizing cartridge via the parallel path to optionally bypass the remineralizing cartridge and provide low TDS water. Additionally, the remineralization device has a user interface that allows a user to choose from various modes between set TDS levels, and/or input the custom TDS level based on user preferences. The remineralization device further creates a custom mineral content or TDS level in water by soaking in water the mineral particles of the remineralizing cartridge and collecting water in a water tank when the custom TDS level is reached. The remineralization device uses soak-based mineralizing that comprises configuring a valve in line with the remineralizing cartridge to control water flow the remineralization device and closing the valve after a set amount of water enters the remineralizing cartridge. It further includes opening the valve when the custom TDS level is reached and collecting water in a water tank that is fluidly connected to the outlet of the remineralizing cartridge.

In yet another embodiment, a remineralization system includes a water purification system and a remineralization device to process drinking water. The remineralization device creates a custom mineral content or TDS level in water using recirculation-based mineralizing. The remineralization device includes a remineralizing cartridge for dissolving minerals, multiple valves for controlling water flow, and a water pump for circulating water until the custom TDS level is reached. The valves control the amount of water flowing through the cartridge, forming a loop between the cartridge and a parallel path. The water is recirculated through the remineralizing cartridge until the custom TDS level is reached. The remineralization device further includes a TDS sensor to monitor TDS levels and a water tank to collect and increase the amount of water that can be remineralized at one time. The valves fluidly connect the inlet and outlet of the remineralizing cartridge and bypass the remineralizing cartridge via the parallel path to provide low TDS water. Additionally, the remineralization device has a user interface that allows a user to choose from various modes between set TDS levels, and/or input the custom TDS level based on user preferences. The remineralization device further creates a custom mineral content or TDS level in water by soaking in water the mineral particles of the remineralizing cartridge and collecting water in a water tank when the custom TDS level is reached. The remineralization device uses soak-based mineralizing operable to configure a valve in line with the remineralizing cartridge to control water flow the remineralization device and close the valve after a set amount of water enters the remineralizing cartridge. It further opens the valve when the custom TDS level is reached and collects water in a water tank that is fluidly connected to the outlet of the remineralizing cartridge.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIG. 1 illustrates a remineralization system for creating a custom mineral content or total dissolved solids (TDS) level in water;

FIGS. 2A-2B illustrate a planar view and a structural view of a remineralization device of the remineralization system respectively;

FIG. 3A illustrates the custom TDS level creation at the remineralizing cartridge through soak-based mineralization;

FIG. 3B illustrates the custom TDS level creation at the remineralizing cartridge through recirculation-based mineralization;

FIG. 4 illustrates a recirculation-based mineralization method to create custom TDS levels at the remineralizing cartridge; and

FIG. 5 illustrates a soak-based mineralization method to create custom TDS levels at the remineralizing cartridge according to an embodiment.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability, or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

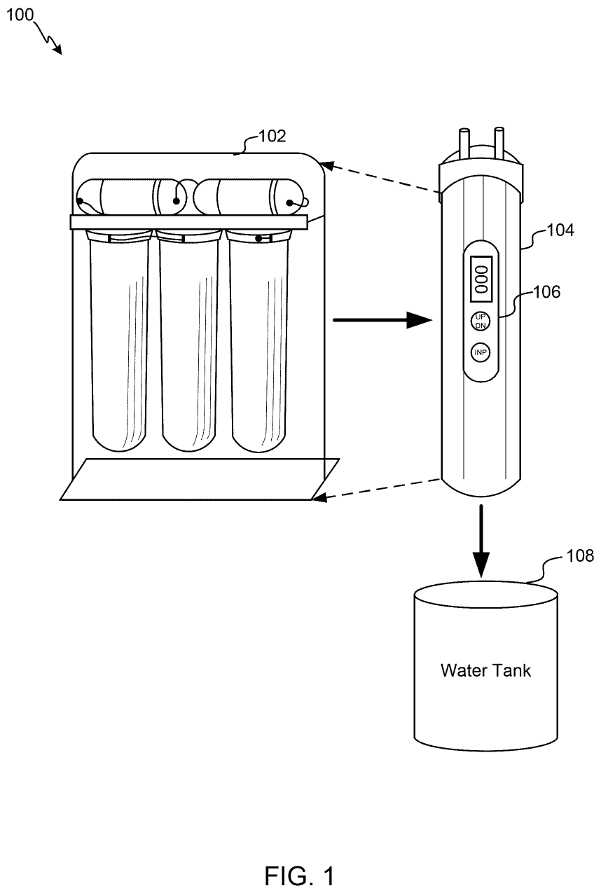

Referring to FIG. 1, a remineralization system 100 for creating a custom mineral content or total dissolved solids (TDS) level in water is shown. The remineralization system 100 processes drinking water using a remineralization device to create custom mineral content or TDS levels in a final drinking water stream. The remineralization system 100 includes a water purification system and a remineralization device. The remineralization device uses a remineralizing cartridge or mineralizer on any type of purified water source, particularly reverse osmosis (RO), RO/DI, or distilled water. The remineralization system 100 could also be used on non-purified water or other types of filtered water, but the effect would not be as great. Through the remineralization system 100, the mineral content in drinking water can be varied and ultimately be much higher than that is achieved by many of the commercially available devices in use today.

The remineralization system 100 includes a RO system 102, a remineralization device 104 with a user interface 106, and a water tank 108. The RO system 102 is a water purification technology that uses a semi-permeable membrane to remove ions, molecules, and large particles from drinking water. The RO system 102 improves water quality by eliminating contaminants like salts, heavy metals, and other impurities. Moreover, the RO system 102 enhances the taste of water by removing chlorine and other substances that affect the taste of water. The RO system 102 is widely used in residential settings for drinking water, in industrial processes for water treatment, and in aquariums and hydroponics where water purity is fundamental. In one embodiment, any other water purifying technology can be used beside the RO system 102 and the remineralization system 100 will work the same.

The remineralization device 104 includes a remineralizing cartridge that is commonly used in the industry to dissolve minerals into the water. The remineralization device 104 has an assembly of water pumps, valves, remineralizing cartridge, and an optional water tank to increase the water holding capacity. The remineralization device 104 also has the user interface 106 that allows users to input custom TDS levels as per user preferences or select from the device's set TDS levels i.e., high, medium, low, etc. Some embodiments allow specifying a target TDS level after remineralization of the RO purified water.

The water tank 108 holds the water exiting the remineralization device 104 i.e., water with custom TDS levels. In one embodiment, the water tank 108 is part of the remineralization device 104, thus a separate installation is not entailed. The water tank 108 increases the water holding capacity of the remineralization system 100. Though, other means can also be used to increase the water holding capacity of the remineralization system 100.

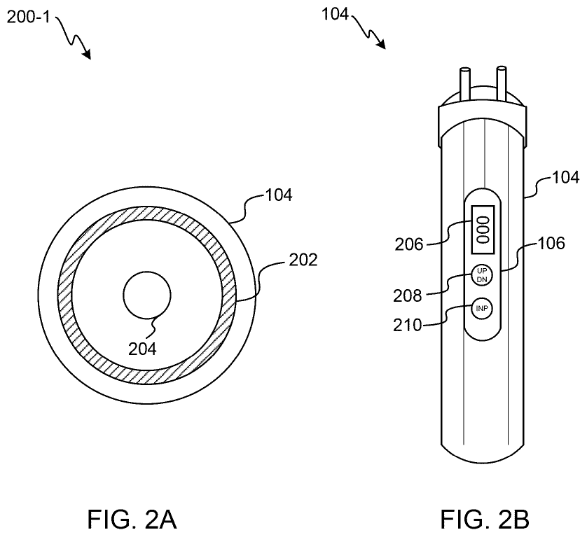

Referring next to FIG. 2A, a planar view 200-1 of the remineralization device 104 of the remineralization system 100 is shown according to an embodiment. The remineralization device 104 houses a remineralizing cartridge 202 and has a water outlet 204 at the end. The remineralizing cartridge 202 is a unit which has granular minerals which slowly dissolve into the water, mimicking how natural mineral water obtains minerals by passing through/against various rocks. The remineralizing cartridge 202 is commonly used in industry and is available in cleanable, back-washable metal media, or in disposable form. The planar view 200-1 shows an exemplary view of the remineralizing cartridge 202 that typically looks like beads or stones in an encapsulation. Other variations of the remineralizing cartridge 202 can also be used. A vast variety of materials, textures, pore sizes, and physical sizes are available for the remineralizing cartridge 202. Disposable cartridges can be woven, nonwoven, or pleated and constructed of many types of fibers. The fibers can also be charged to aid in filtration. The planar view 200-1 shows one way of using the remineralizing cartridge 202 inside the remineralization device 104, other design approaches can also be used. This application emphasizes how the mineral content in the water can be varied and ultimately be much higher than that is achieved by many of the commercially available devices in use today.

Referring next to FIG. 2B, a structural view of a remineralization device 104 of the remineralization system 100 is shown according to an embodiment. The remineralization device 104 is an exemplary device for creating custom TDS levels in drinking water, other approaches can also be used. The remineralization device 104 has the user interface 106 that allows users to input custom TDS levels as per user preferences or select from the device's set TDS levels i.e., high, medium, low, etc. The user interface 106 has an LED display 206 for displaying current TDS level of water in the remineralization device 104. Furthermore, the user interface 106 has an up/down button 208 that allows users to control the TDS level, and an input button 210 through which users can input their custom TDS level. The user interface 106 can have other controls and monitors that are not shown here, to increase the accessibility and create a user-friendly experience. In one embodiment, the remineralization device 104 has a TDS sensor to monitor the TDS levels throughout the mineralization process. In another embodiment, the remineralization device 104 has a timer that monitors the period for which water is recirculated/soaked through the remineralizing cartridge 202 to achieve a certain TDS level.

In one embodiment, the remineralization device 104 can also provide water with low TDS levels based on user preferences. Besides adjusting the flavor of drinking water, the remineralization device 104 can be used for multiple purposes. For instance, coffee has specific TDS levels at which the coffee tastes best, so the remineralization device 104 could be used in conjunction with a coffeemaker. Additional characteristics of the water could be controlled to offer more options, such as temperature or carbonation level.

In another embodiment, multiple remineralizing cartridges could be made commercially available with each having a different mineral content and thus flavor profile, further allowing users to select both the flavor profile and flavor intensity according to each user's preferences. Recirculation through each of the multiple remineralizing cartridges could be independently controlled with different valves to further customize the flavor profile and intensity.

Additionally, the remineralization device 104 can achieve a broad range of TDS levels while only using purified water, ensuring that no harmful contaminants are passed through to the end product water. For example, the remineralization device 104 is able to recreate mineral water (over 250 ppm of TDS) starting with pure RO water of ~5 ppm of TDS. The common tap water is closer to 220 ppm TDS, so the mineral content can be higher than the unpurified water. This would be impossible by just blending the purified and unpurified water streams.

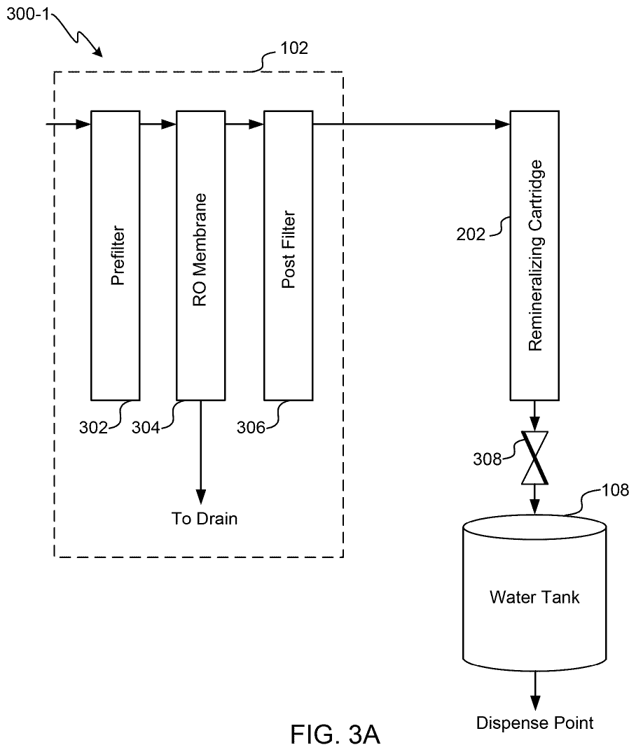

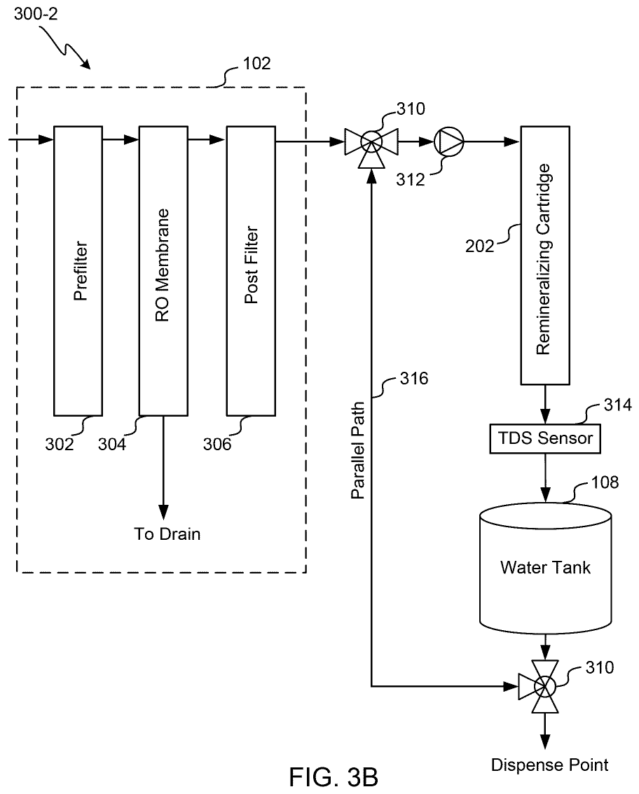

Referring next to FIG. 3A, the custom TDS level creation at the remineralizing cartridge 202 through soak-based mineralization 300-1 is shown according to an embodiment. Soak-based mineralization 300-1 involves soaking solid minerals in water that facilitate increasing the mineral content of the water. In context of water mineralization, the incoming water is soaked around solid minerals to form a solution with a high concentration of dissolved solids. This results in an increase in the mineral level of the incoming water. The remineralization system 100 creates a custom mineral content or TDS level in water by soaking in water the mineral particles of the remineralizing cartridge 202 and collecting water in a water tank when the custom TDS level is reached. The soak-based mineralization 300-1 method includes the RO system 102, the remineralizing cartridge 202, a valve 308, and the water tank 108.

The RO system 102 includes a prefilter 302, an RO membrane 304, and a post filter 306. Before the water reaches the RO membrane 304, the water typically goes through the prefilters 302 (like sediment and carbon filters). The prefilter 302 removes larger particles and chlorine, which can damage the RO membrane 304. The pre-treated water is then pumped through the RO membrane 304 at high pressure. This pressure is necessary to overcome the natural osmotic pressure, allowing the water to flow from the more concentrated solution (contaminated water) to the less concentrated side (purified water). The semi-permeable membrane has tiny pores that allow water molecules to pass through while blocking larger molecules, ions, and contaminants. This separation results in purified water on one side and a concentrated waste stream (brine) on the other. After passing through the RO membrane 304, the purified water may go through additional post-filters. The post filter 306 removes the remaining tastes or odors, ensuring the water is clean and palatable. The purified water is then stored in a tank for later use, while the water waste is usually directed to a drain.

The prefiltered water then enters the remineralizing cartridge 202 where TDS levels of the prefiltered water are either enhanced or reduced. In soak-based mineralization 300-1, a valve 308 is placed in line with the remineralizing cartridge 202. The valve 308 controls the water flow through the remineralization system 100. In this embodiment, the valve 308 is placed after the remineralizing cartridge 202, but has the same effect when placed before the remineralizing cartridge 202 as well. The valve 308 is closed after a set amount of water enters the remineralizing cartridge 202, and is opened after a set period, once a desired TDS level is reached. An optional holding tank/the water tank 108 could be fluidly connected to the outlet of the remineralizing cartridge 202, to collect water at the higher TDS level. Alternatively, the water could be dispensed directly into the user's container, such as a glass pitcher, and filled up slowly over time. The water tank 108 helps to control the TDS level more accurately, as the TDS level could be monitored in the water tank 108 and the hold time in the remineralizing cartridge 202 could be adjusted to ensure the desired/custom TDS level is reached.

Referring next to FIG. 3B, the custom TDS level creation at the remineralizing cartridge 202 through recirculation-based mineralization 300-2 is shown according to an embodiment. In recirculation-based mineralization 300-2, water is continuously circulated through the remineralizing cartridge 202. This allows for repeated exposure to dissolved solids, thus enhancing the mineral content of the water. During recirculation, essential minerals (like calcium and magnesium) are added back into the water. This not only helps in enhancing taste but also supports the re-mineralization process, which is beneficial for health. The water can be treated beforehand, using various methods, such as filtration, UV treatment, or chemical processes, to remove impurities and pathogens before minerals are added back. By controlling the mineral content, the remineralization system 100 ensures that the water remains balanced and stable, making the water more pleasant and beneficial for consumption.

The recirculation-based mineralization 300-2 method includes the RO system 102, the remineralizing cartridge 202, three-way valves 310, a water pump 312, and the water tank 108. In the recirculation-based mineralization 300-2, the three-way valves 310 are placed both before and after the remineralizing cartridge 202. The three-way valves 310 are used to control the amount of water flowing through the remineralizing cartridge 202, and to close an inlet and an outlet of the remineralizing cartridge 202 to form a loop between the remineralizing cartridge 202 and a parallel path 316. A water pump 312 is placed in between the remineralizing cartridge 202 and one of the three-way valves 310. The water pump 312 is placed either at the inlet or outlet side of the remineralizing cartridge 202. The three-way valves 310 on both ends are fluidly connected via the parallel path 316. During the recirculation phase, the three-way valves 310 are set to isolate both the inlet and the outlet, forming a closed loop between the remineralizing cartridge 202 and the parallel path 316. The water pump 312 would then run for a set period, until the desired TDS level is achieved. An optional holding tank/the water tank 108 is also used in the recirculation-based mineralization 300-2. The water tank 108 increases the amount of water which can be remineralized at one time.

Alternatively, the remineralizing cartridge 202 could just be made large enough to avoid the need for an external tank. In the recirculation-based mineralization 300-2, the water in the parallel path 316 can flow in both directions, assuming the remineralization device 104 is attached to a pressurized source at the inlet or has another onboard pump. This would allow the three-way valves 310 to shut off to the remineralizing cartridge 202 while fluidly connecting the inlet and outlet via the parallel path 316. In this way, the valves bypass the remineralizing cartridge 202 by fluidly connecting the inlet and outlet of the remineralizing cartridge 202 via the parallel path 316 to provide low TDS water. This allows for delivering pure, low TDS water which has not been mineralized at all if the user prefers this for flavor or for other applications (such as cleaning glass/mirrored surfaces).

In one embodiment, an algorithm is developed to soak or recirculate the water for a set period to achieve multiple levels like low, medium, or high TDS levels. In another embodiment, a TDS sensor 314 could be placed just after the remineralizing cartridge 202 to read and adjust the TDS levels of the water. The remineralization device 104 can then use a control board to determine how long to soak or recirculate the water until the desired set point is achieved. The user interface 106 could similarly have a variety of options, ranging from the user picking between set TDS levels, to being able to custom input a target TDS level that the user prefers.

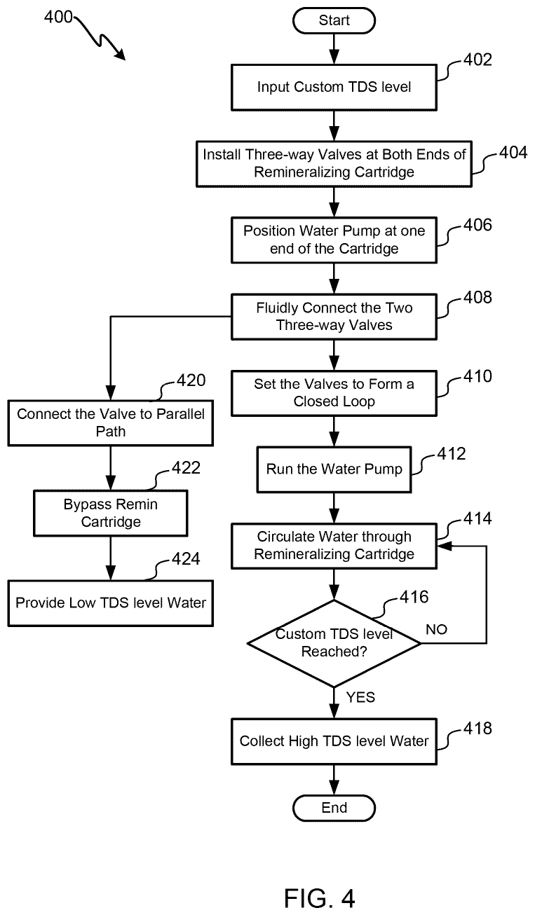

Referring next to FIG. 4, a recirculation-based mineralization method 400 to create custom TDS levels at the remineralizing cartridge 202 is shown according to an embodiment. At block 402, the user inputs the desired/custom TDS level for water intake. The custom TDS level can be input from the user interface 106 of the remineralization device 104, or the user can select from different levels, i.e., high, medium, and low, from the user interface 106.

At block 404, the three-way valve 310 is installed at the inlet and outlet of the remineralizing cartridge 202. The three-way valves 310 control the amount of water entering the remineralizing cartridge 202 and manages the water flow. At block 406, the water pump 312 is placed at one end of the remineralizing cartridge 202. In the recirculation-based mineralization 300-2, the water pump 312 is positioned at the inlet of remineralizing cartridge 202. However, it will have the same effect if placed at the outlet of the remineralizing cartridge 202.

At block 408, both three-way valves are fluidly connected with each other. This way the parallel path 316 to the remineralizing cartridge 202 is created. At block 410, the three-way valves 310 are closed to form a closed loop through which water is recirculated. With the valves isolating the closed loop from the inlet pressure, the water in the parallel path 316 can now flow freely in whichever direction the water is pumped.

At block 412, the water pump 312 is turned ON and water is circulated through the remineralizing cartridge 202 at block 414. The remineralizing cartridge 202 is a unit which has granular minerals which slowly dissolve into the water, mimicking how natural mineral water obtains minerals by passing through/against various rocks. At block 416, the remineralization device 104 checks whether the custom TDS level has reached or not.

If the custom TDS level is not yet achieved, the water is recirculated through the remineralizing cartridge 202 till the desired level is obtained. On the other hand, if the custom TDS level is achieved, the high TDS level water is collected in the water tank 108 at block 418. Alternatively, the design for the remineralization device 104 can be adjusted to store the high TDS level water instead of using the water tank 108.

At block 420, the three-way valves 310 are set to fluidly connect the parallel path 316 to the inlet and outlet while isolating the remineralizing cartridge. At block 422, the water in the parallel path 316 bypasses the remineralizing cartridge 202. This allows for delivering pure, low TDS water which has not been remineralized at all if the user prefers this for flavor or for other applications (such as cleaning glass/mirrored surfaces). Finally, at block 424, the low TDS level water is provided to the user.

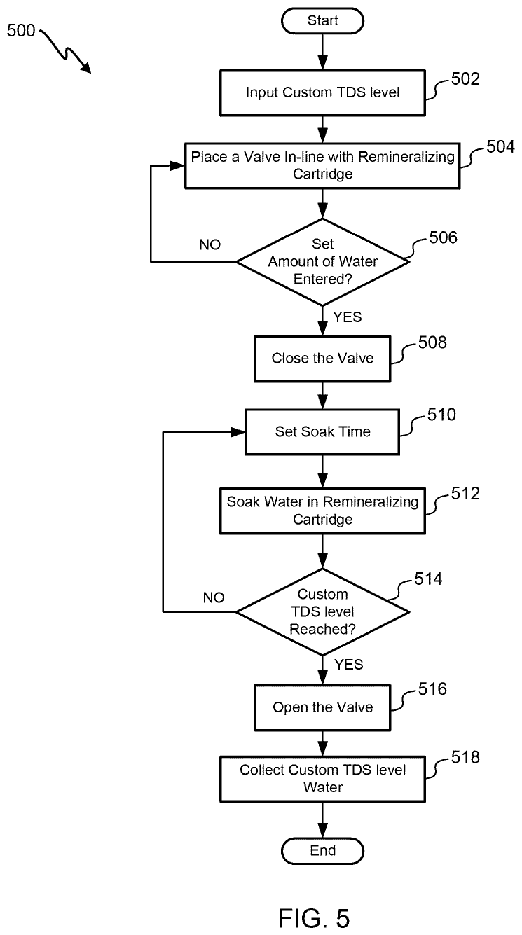

Referring next to FIG. 5, a soak-based mineralization method 500 to create custom TDS levels at the remineralizing cartridge 202 is shown according to an embodiment. The remineralization system 100 creates a custom mineral content or TDS level in water by soaking mineral particles of the remineralizing cartridge 202 in water and collecting water in a water tank when the custom TDS level is reached. At block 502, the user inputs the desired/custom TDS level for water intake. The custom TDS level can be input from the user interface 106 of the remineralization device 104 or the user can select from different levels, i.e., high, medium, and low from the user interface 106.

At block 504, a valve 308 is placed in line with the remineralizing cartridge 202, controlling the water flow through the remineralization system 100. Presumably, the valve 308 is placed after the remineralizing cartridge 202, but has the same effect when placed before remineralizing cartridge 202 as well. At block 506, the remineralization device 104 checks whether a set amount of water has entered the remineralizing cartridge 202 or not. If not, the valve 308 allows more water to enter the remineralizing cartridge 202.

On the other hand, if a set amount of water has entered the remineralizing cartridge 202, then the valve 308 is closed at block 508. At block 510, the soak time is set for the remineralization device 104. The soak time can be adjusted by the user to create custom TDS levels or the remineralization device 104 itself can configure the soak time to match user preferences.

At block 512, water is soaked in the remineralizing cartridge 202 for the set time duration. The remineralizing cartridge 202 is a unit which has granular minerals which slowly dissolve into the water, mimicking how natural mineral water obtains minerals by passing through/against various rocks. At block 514, the remineralization device 104 checks whether the custom TDS level has reached or not.

If the custom TDS level is not yet achieved, the soak time is readjusted to obtain the desired TDS level. On the other hand, if the custom TDS level is achieved, the valve 308 is opened at block 516 so water can be dispensed from the remineralizing cartridge 202. Finally, at block 518, the high TDS level water is collected in the water tank 108. Alternatively, the design for the remineralization device 104 can be adjusted to store the high TDS level water instead of using the water tank 108.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process that is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine-readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read-only memory (ROM), random access memory (RAM), magnetic RAM, core memory, magnetic disk storage mediums, optical storage mediums, flash memory devices and/or other machine-readable mediums for storing information. The term “machine-readable medium” includes but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as a limitation on the scope of the disclosure.

We claim:

1. A remineralization device for creating a custom mineral content or total dissolved solids (TDS) level in water using recirculation-based mineralization, the remineralization device comprising:
a remineralizing cartridge to dissolve minerals into the water;
a plurality of valves placed in line with the remineralizing cartridge, wherein the plurality of valves is configured to:
control an amount of water flowing through the remineralizing cartridge, and
close an inlet and outlet of the remineralizing cartridge to form a loop between the remineralization cartridge and a parallel path; and
a water pump placed between the remineralizing cartridge and the plurality of valves to circulate the water through the remineralizing cartridge until the custom TDS level is reached.

2. The remineralization device of claim 1, wherein the remineralization device further comprises a water tank to collect and increase the amount of water that can be remineralized at one time.

3. The remineralization device of claim 1, wherein the plurality of valves is fluidly connected to a point upstream and a second point downstream of the remineralizing cartridge via the parallel path to bypass the remineralizing cartridge and provide low TDS water.

4. The remineralization device of claim 1, wherein the water in the parallel path flows in both directions using the water pump or a plurality of water pumps.

5. The remineralization device of claim 1, wherein the remineralization device further comprises a TDS sensor to read and adjust mineral content or TDS level of the water.

6. The remineralization device of claim 1, wherein the remineralization device further comprises a user interface to allow a user to:
choose from a plurality of modes between set TDS levels, and/or
input the custom TDS level based on user preferences.

7. The remineralization device of claim 1, wherein the remineralization device further creates a custom mineral content or total dissolved solids (TDS) level in water by:
soaking in water, a plurality of mineral particles of the remineralizing cartridge; and
collecting water in a water tank when the custom TDS level is reached.

8. A method for creating a custom mineral content or total dissolved solids (TDS) level in water using recirculation-based mineralization at a remineralization device, the method comprising:
placing a plurality of valves in line with a remineralizing cartridge that dissolves minerals into the water, wherein the plurality of valves is configured to:
controlling an amount of water flowing through the remineralizing cartridge, and
closing an inlet and outlet of the remineralizing cartridge to form a loop between the remineralizing cartridge and a parallel path; and
circulating the water through the remineralizing cartridge via a water pump placed between the remineralizing cartridge and the plurality of valves, until the custom TDS level is reached.

9. The method for creating a custom mineral content or TDS level in water of claim 8, wherein the remineralization device comprises a water tank to collect and increase the amount of water that can be remineralized at one time.

10. The method for creating a custom mineral content or TDS level in water of claim 8, wherein the plurality of valves is fluidly connected to a point upstream and a second point downstream of the remineralizing cartridge via the parallel path to bypass the remineralizing cartridge and provide low TDS water.

11. The method for creating a custom mineral content or TDS level in water of claim 8, wherein the water in the parallel path flows in both directions using the water pump or a plurality of water pumps.

12. The method for creating a custom mineral content or TDS level in water of claim 8, the method further comprises reading and adjusting TDS level of water using a TDS sensor.

13. The method for creating a custom mineral content or TDS level in water of claim 8, the method further comprises inputting the custom TDS level using a user interface at the remineralization device, which allows a user to:
choose from a plurality of modes between set TDS levels, and/or
input the custom TDS level based on user preferences.

14. The method for creating a custom mineral content or TDS level in water of claim 8, wherein the method further creates a custom mineral content or total dissolved solids (TDS) level in water by:
soaking in water, a plurality of mineral particles of the remineralizing cartridge; and
collecting water in a water tank when the custom TDS level is reached.

15. A remineralization system to process drinking water, the remineralization system comprising:
a water purification system; and
a remineralization device for creating a custom mineral content or total dissolved solids (TDS) level in water using recirculation-based mineralization, wherein the remineralization device comprises:
a remineralizing cartridge to dissolve minerals into the water;
a plurality of valves placed in line with the remineralizing cartridge, wherein the plurality of valves is configured to:
control an amount of water flowing through the remineralizing cartridge, and
close an inlet and outlet of the remineralizing cartridge to form a loop between the remineralizing cartridge and a parallel path; and
a water pump placed between the remineralizing cartridge and the plurality of valves to circulate the water through the remineralizing cartridge until the custom TDS level is reached.

16. The remineralization system of claim 15, wherein the remineralization device further comprises a water tank to collect and increase the amount of water that can be remineralized at one time.

17. The remineralization system of claim 15, wherein the plurality of valves is fluidly connected to a point upstream and a second point downstream of the remineralizing cartridge via the parallel path to bypass the remineralizing cartridge and provide low TDS water.

18. The remineralization system of claim 15, wherein the remineralization device further comprises a TDS sensor that reads and adjusts the mineral content or TDS level of the water.

19. The remineralization system of claim 15, wherein the remineralization device further comprises a user interface to allow a user to:
choose from a plurality of modes between set TDS levels, and/or
input the custom TDS level based on user preferences.

20. The remineralization system of claim 15, wherein the remineralization device further creates a custom mineral content or total dissolved solids (TDS) level in water by:
soaking in water, a plurality of mineral particles of the remineralizing cartridge; and
collecting water in a water tank when the custom TDS level is reached.
